(19) United States
(12) Patent Application Publication
(10) Pub. No.: US 2019/0329259 A1
(43) Pub. Date: Oct. 31, 2019

(54) DIGITAL MICROFLUIDIC DEVICES

(71) Applicant: Digital BioSystems, Menlo Park, CA (US)

(72) Inventor: Chuanyong Wu, Menlo Park, CA (US)

(21) Appl. No.: 16/462,156

(22) PCT Filed: Nov. 14, 2017
(86) PCT No.: PCT/US2017/061546

§ 371 Date: May 17, 2019

Related U.S. Application Data
(60) Provisional application No. 62/423,889, filed on Nov. 18, 2016.

(51) Int. Cl. B01L 3/00

(52) U.S. Cl. CPC B01L 3/502792; B01L 2300/0627; B01L 2300/0654; B01L 2300/0887; B01L 2400/0421; B01L 2400/0427; B01L 2400/0424; B01L 2300/168; B01L 2400/0418; B01L 2300/165

(57) ABSTRACT

The disclosure relates to the routing of droplet control signals in a digital microfluidic device. The digital microfluidic devices can comprise a first substrate having droplet control electrodes in one layer and at least some droplet control signal lines in another layer, and these two layers are separated by a layer of dielectric material patterned with VIAs. At least some of the electrodes and control signal lines are electrically connected through the VIAs. A second dielectric layer is deposited on the first substrate to cover at least some of the droplet control electrodes. Droplets may then be operated using electrowetting, dielectrophoresis, or other electrostatic mechanisms by applying voltages to the desired electrodes.

### CROSS-REFERENCE TO RELATED CASES

The present application claims priority to U.S. Provisional Application No. 62/423,889, filed Nov. 18, 2016, the entire contents of which are incorporated herein by reference.

### FIELD OF INVENTION

The present disclosure relates generally to apparatuses and methods for performing droplet operations. It relates to the design and fabrication of digital microfluidic devices and to the routing of the droplet control signals in said devices. Said control signals provide droplet operation capabilities such as droplet dispensing, transporting, merging/mixing, splitting, shaping, particle redistribution within a droplet, etc.

### BACKGROUND

Digital microfluidics (DMF) offers the ability to control individual droplets. It offers many advantages such as reconfigurable (real-time by software) and reversible droplet paths, liquid (samples or reagents) independent device design, all electronic (low voltage) control, low power consumption operating the device, among many others. Compared with channel based microfluidic devices, where liquids are typically handled in a continuous-flow fashion, a digital microfluidic device presents more direct similarities to a miniaturized bench lab, in which liquids are handled in a discrete format. Bench lab biochemical protocols can be easily adopted to droplet based protocols. Hence, digital microfluidics truly offers the functionality of lab-on-a-chip, and as such, is a rapidly advancing field.

Digital microfluidics offers methods to manipulate liquid droplets and/or the particles in the droplets by employing electrostatic mechanisms such as electrowetting, electrophoresis, and dielectrophoresis, etc. It provides droplet operation capabilities such as droplet dispensing, transport, merging and mixing of two or more droplets, splitting one droplet into two (or more) daughter droplets, incubation, waste disposal, particle (such as DNA/RNA/protein molecules, cells, beads, etc.) redistribution/enrichment/separation, etc. Droplet microfluidics provides the capability to essentially handle all the basic steps of liquid analysis, include sampling, sample preparation, reaction, detection, and waste handling, etc. It can practically handle droplets with volume ranging from a few pico-liters to tens of microliters—a span of more than six orders of magnitude. It finds applications in medical diagnostics, cancer screening, drug discovery, food safety inspection, environmental monitoring, forensic analysis, and many others. Besides miniaturization and integration, it offers other advantages such as low cost, automation, parallelism, high throughput, low energy consumption, etc.

A typical digital microfluidic device consists of two solid substrates separated by a spacer to form a gap in-between. Liquids are operated in the gap in a discrete fashion, i.e., in the format of droplets. Different from channel based microfluidics, in digital microfluidics, the droplet path can be changed during run-time by the control software, and droplets can be operated individually. Digital microfluidics truly fulfills the promise of the lab-on-a-chip concept, which is to handle all the basic steps of an analysis, including sampling, sample preparation, reaction, detection, and waste handling, etc. Digital microfluidics shares great similarities with bench based liquid handling. Established bench based protocols can be easily adapted to the digital microfluidics format.

Currently, existing DMF devices often have issues with limited complexity, robustness, fabrication cost, etc. For example, a typical single-layer-electrode design has droplet control electrodes and the control signal lines fabricated in the same layer on a substrate surface. The signal routing is typically an issue for a DMF device of practical use. Also, the signal control lines often make the droplet operations more complicated, as they can act on droplets unintendedly.

Since multilayer electrical access lines can be created inexpensively using the mature printed circuit board (PCB) technology, to make DMF devices with enough complexity for practical applications, PCBs have been utilized as the substrates for the droplet control electrodes, in which the signal control lines can be routed in the inner layers or on the opposite side (of the electrodes). The most popular metal used in PCBs is copper. However, the typical thicknesses of the metal layers in a PCB are not best suited for effecting droplets by means of electrowetting or other electrostatic mechanisms. For example, 18 μm (micrometer) and 35 μm seem to be the common thicknesses of a copper layer in a PCB, and 9 μm is sometimes available on some substrates, but these can all be too thick for optimal droplet operations. Certain metal thicknesses are often needed in PCBs as the metal traces usually need to carry electrical signals with a certain current. In a DMF device, the electrodes behave like small capacitors in the range of pF (pico Farad) to nF (nano Farad). The electrical current during the capacitor charging and discharging is typically very small, which means that the conductive material can be made very thin for the purposes of routing the droplet control signals.

The relatively thick metal layers, especially the top one for the electrodes, make the surface uneven for droplet movement. The dielectric layer used to cover the electrodes needs to be thick enough to make sure the electrodes are not directly exposed to the droplets. This can sometimes make the droplet control voltage unacceptably high (>500 volts).

People have employed approaches for decreasing the droplet operation voltage by adding post-PCB microfabrication processes to improve the surface flatness and reduce the thickness of the dielectric layer. Approaches include (1) removing the copper electrodes on top of the PCB to achieve a flat surface and depositing/patterning a thinner metal layer to make the electrodes; and (2) using chemical mechanical polishing (CMP) to make the surface flat; etc. However, each of these additional post-PCB steps increases the cost.

There are other issues when choosing a PCB as the substrate for a DMF device. For example, most of the common PCBs are opaque, and are not compatible with optical measurement. Transparent PCBs are available, but the background fluorescence from the PCB materials make it a challenge for sensitive optical detections.

### SUMMARY

The present disclosure presents design and manufacturing approaches for making a DMF device, in which at least two conductive layers are made. In one embodiment, one layer is for the droplet control electrodes and the other layer is for droplet control signal routing. This design allows the droplet operations such as droplet dispensing, transport, merging and mixing of multiple droplets, splitting one droplet into two (or more) daughter droplets, incubation, waste disposal, particles (such as DNA/RNA/protein molecules, cells, beads, etc.) redistribution/enrichment/separation, etc., on said DMF device. Furthermore, the presently described devices can simplify droplet control and make it easier to increase the device reliability when compared to conventional devices in the field.

### BRIEF DESCRIPTION OF THE DRAWINGS

FIG. 1A is a cross-sectional view of a digital microfluidic device with droplet control electrodes disposed in the top conductive layer while the signal routing lines are disposed in the bottom conductive layer on the lower plate. One or more vertical interconnect accesses (VIAs) are made in the dielectric layer between the two conductive layers to provide conductive connections between some of the droplet control electrodes in the top conductive layer and some of the signal routing lines in the bottom conductive layer. FIGS. 1B-1D show the design patterns of the different layers on the lower plate, and FIG. 1E is the combined view of the different layers.

FIGS. 2A-2C present the design of different layers on the lower plate of another digital microfluidic device with droplet control electrodes in the top conductive layer. Some of the signal connection lines are in the top conductive layer, and some are in the bottom conductive layer. VIAs are used for making electrical connections of some of droplet control electrodes in the top conductive layer and some of signal routing lines in the bottom conductive layer. FIG. 2D is the combined view of the layers.

FIGS. 3A-3C present the design of different layers on the lower plate of yet another digital microfluidic device with droplet control electrodes in the top conductive layer. Some of the signal connection lines are in the top conductive layer, and some are in the bottom conductive layer. VIAs are used for making electrical connections of some of droplet control electrodes in the top conductive layer and some of signal routing lines in the bottom conductive layer. FIG. 3D is the combined view of the layers.

FIGS. 4A-4F illustrate the droplet transport function using the device design presented in FIGS. 3A-3D.

FIGS. 5A-5E present a design of a digital microfluidic device in which the droplet control electrodes, as well as the signal control lines, are in two electrically separated layers. From a droplet operation functionality point of view, it is equivalent to the device illustrated in FIGS. 3A-3D.

### DETAILED DESCRIPTION

The following are the definitions and/or explanations of some of the terminologies used in the present disclosure.

For purposes of the present disclosure, the phrases “microfluidic devices” and “microfluidic chips” have their ordinary meaning in this field and are used interchangeably to refer to a device or a system having the capability of manipulating liquid with at least one cross-sectional dimension in the range of from a few micrometers to about a few hundred micrometers.

For purposes of the present disclosure, the phrases “droplet microfluidic device” and “digital microfluidic device” have their ordinary meaning in this field and are used interchangeably to denote a microfluidic device in which liquid is handled in a discrete format, i.e., droplets. Droplets can be individually manipulated.

For purposes of the present disclosure, the term “droplet” has its ordinary meaning in this field and is used to indicate one type of liquid (or a few types mixed together) of limited volume separated from other parts of liquid of the same type by air (or other gases), other liquids (typically not immiscible ones), or solid surfaces (such as inner surfaces of a DMF device), etc. A droplet can take any arbitrary shape, such as sphere, semi-dome, flattened round, or irregular, etc. In some embodiments, the volume of the droplets may range from 1 pL (pico-liter) to 200 uL (microliter), from 10 pL to 100 uL, or from 100 pL to 50 uL.

In this disclosure, the term “particles” has its ordinary meaning in this field and is used to indicate micrometric or nanometric entities, either natural or artificial, such as cells, sub-cellular components, viruses, liposomes, nano-spheres, and micro-spheres, or even smaller entities, such as macro-molecules, proteins, DNAs, RNAs, etc., as well as droplets of liquid immiscible with the suspension medium, or bubbles of gas in liquid. The sizes of the “particles” range from a few nanometers to hundreds of micrometers.

Without being bound to particular theory, the term “electrostatics” or “electrostatic mechanism” have their ordinary meaning in this field and are used to indicate phenomena or properties of stationary or slow-moving electric charges. Here the term “slow-moving” is used only to indicate that the phenomena or properties due to the attractions or repulsions of electric charges are not dependent upon their motion. Some of the non-exhaustive examples of “electrostatic mechanism” are electrowetting, dielectriophoresis, electrophoresis, electroosmosis, etc.

The term “electrowetting” has its ordinary meaning in this field and is used to indicate the effect that the change of the contact angle between a liquid and a solid surface due to an applied electric field. In some embodiments, when AC (Alternating Current) voltages or electric fields are applied, both the electrowetting effect and the dielectrophoretic effect can exist. As the frequency of the AC voltages or electric fields increases, the dielectrophoretic effect will be more pronounced compared to the electrowetting effect. It is not the intent to strictly differentiate the electrowetting effect and the dielectrophoretic effect.

The term “electrophoresis” has its ordinary meaning in this field and is used to indicate the phenomenon in which a charged particle suspended in a liquid medium or gel experiences a force under the influence of a spatially uniform electric field. Electrophoresis is a technique used in laboratories in order to separate and analyze macromolecules (DNA, RNA, and proteins) and their fragments, based on their molecular size and electrical charge.

The term “dielectrophoresis” (DEP) has its ordinary meaning in this field and is used to indicate the phenomenon in which a neutral particle experiences a force when it is subjected to a non-uniform electric field. When a particle suspended in a liquid medium is exposed to a non-uniform electric field, it experiences a force that can cause it move to a region of higher electric field (positive dielectrophoresis) or to a region of lower electric field (negative dielectrophoresis). Unlike electrophoresis, the dielectrophoretic force does not require the particle to have charge. Also, the dielectrophoretic force is insensitive to the polarity of the electric field. The effect of dielectrophoresis can occur in both AC (time varying) and DC (non-time varying) electric fields. All particles exhibit dielectrophoretic activity in the presence of non-uniform electric fields. The strength of the dielectrophoretic force depends on the particle's size and shape, the medium and the particle's electrical properties, as well as the frequency of the electric field.

The term “electroosmosis”, synonymous with “electroosmotic flow”, has its ordinary meaning in this field and is used to describe the motion of liquid induced by an applied potential across a capillary tube, microchannel, or any other fluid conduit.

Apparatuses and methods are provided to detect target analytes in a sample solution. As will be appreciated by those in the art, the sample solution may include, but is not limited to, bodily fluids (including, but not limited to, blood, serum, saliva, urine, etc.), purified samples (such as purified DNA, RNA, proteins, etc.), environmental samples (including, but not limited to, water, air, agricultural samples, etc.), biological warfare agent samples, etc. While bodily fluids can be from any biological entities, in some embodiments, bodily fluids can be from mammals, such as from a human.

For purposes of the present disclosure, the terms “layer” and “film” are used interchangeably to denote a structure of body that is typically but not necessarily planar or substantially planar, and is typically deposited on, formed on, coated on, or is otherwise disposed on another structure.

For purposes of the present disclosure, the term “communicate” (e.g., a first component “communicates with” or “is in communication with” a second component) is used herein to indicate a structural, functional, mechanical, electrical, optical, or fluidic relationship, or any combination thereof, between two or more components or elements. As such, the fact that one component is said to communicate with a second component is not intended to exclude the possibility that additional components may be present between, and/or operatively associated or engaged with, the first and the second components.

For purposes of the present disclosure, it will be understood that when a given component such as a layer, region or substrate is referred to herein as being disposed or formed “on”, “in,” or “at” another component, that given component can be directly on the other component or, alternatively, intervening components (e.g., one or more buffer layers, interlayers, electrodes or contacts) can also be present. It will be further understood that the terms “disposed on” and “formed on” are used interchangeably to describe how a given component is positioned or situated in relation to another component. Hence, the terms “disposed on” and “formed on” are not intended to introduce any limitations relating to methods of material transport, deposition, or fabrication.

For purposes of the present disclosure, it will be understood that when a liquid in any form (e.g., a droplet or a continuous body, whether moving or stationary) is described as being “on”, “at”, “or “over” an electrode, array, matrix or surface, such liquid could be either in direct contact with the electrode/array/matrix/surface, or could be in contact with one or more layers or films that are interposed between the liquid and the electrode/array/matrix/surface.

As used herein, the term “reagent” describes any material useful for reacting with, diluting, solvating, suspending, emulsifying, encapsulating, interacting with, or adding to a sample material.

As used herein, the term “ground” in the context of “ground electrode” or “ground voltage” indicates the voltage of corresponding electrode(s) is set to zero or substantially close to zero.

For purposes of the present disclosure, the term “electronic selector” describes any electronic device capable of setting or changing an output signal to different voltage or current levels with or without intervening electronic devices. As a non-limiting example, a microprocessor along with some driver chips can be used to set different electrodes at different voltage potentials at different times.

For purposes of the present disclosure, the terms “detection” and “measurement” are used interchangeably to denote a process of determining a physical quantity such as position, charge, temperature, concentration, pH, luminance, and fluorescence, etc. Normally, at least one detector (or sensor) is used to measure a physical quantity and convert it into a signal, data, or information which can be read by an instrument or a human. One or more components may be used between the object being measured and the sensor, such as lenses, mirrors, optical fibers, and filters in optical measurements, or resistors, capacitors, and transistors in electronic measurements. Also, other apparatuses or components may be used to make it easier or possible to measure a physical quantity. In some embodiments, when using the fluorescence intensity is used to deduce the particle concentration of, a light source, such as a Laser or Laser diode, may be used to excite the particles to the electronic excited states from their electronic ground state, which emits fluorescence light when returning to their ground states. The sensors can be a CCD (Charge Coupled Device), APD (Avalanche Photodiode), CMOS (Complementary Metal Oxide Semiconductor) camera, a photodiode, a photomultiplier tube, etc., in optical measurements, or operational amplifier, analog-to-digital convertor, thermocouple, thermistor, etc., in electronic measurements.

Detection or measurement can be done to a plurality of signals from a plurality of products, either simultaneously or sequentially. In some embodiments, a photodiode can be used to measure of the fluorescence intensity from a particular type of particles in a droplet, while the position of the said droplet is sensing by a capacitance measurement at the same time. Also, a detector (or sensor) can include or be operably linked to a computer, e.g., which has software for converting detector signals to information that a human or machine can understand. In some embodiments, the fluorescence intensity information is used to deduce the concentration of can be converted to particle concentration.

In integrated circuit design, a VIA (vertical interconnect access) is a small opening in an insulating layer that allows a conductive connection between layers. For purposes of the present disclosure, a VIA is a small opening in the dielectric layer that allows a conductive connection between a droplet control electrode in one conductive layer and a conductive line in another conductive layer.

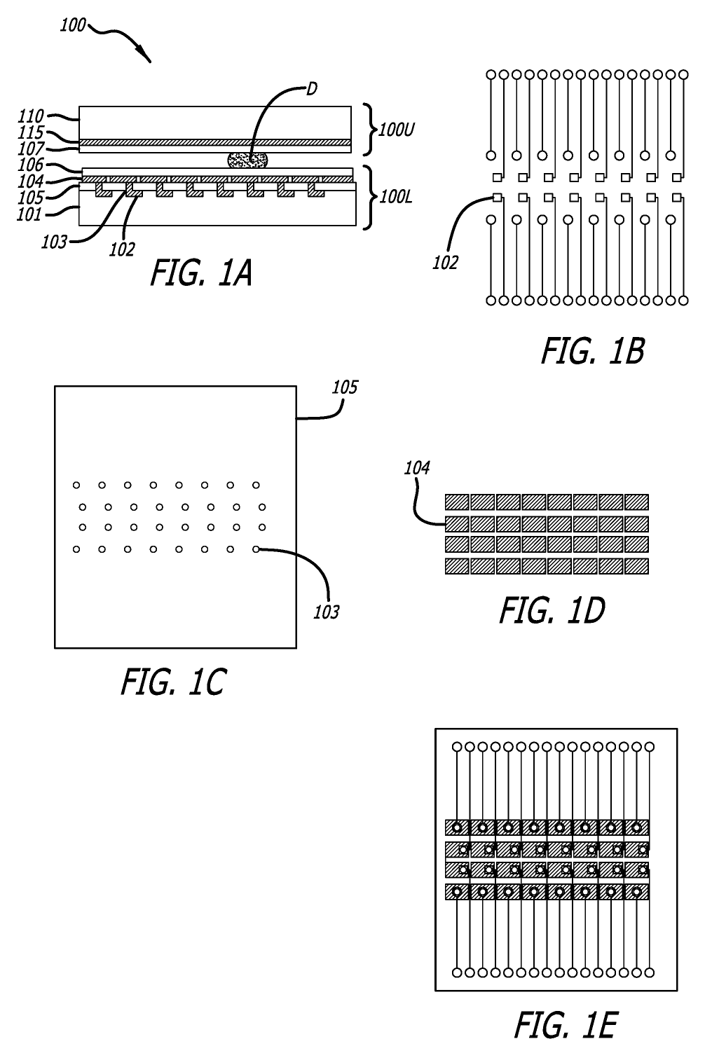

The design of the droplet control electrodes and signal routing signals provided herein will now be illustrated, along with some potential applications, with reference being made as necessary to the accompanying FIGS. 1A-5E.

FIGS. 1A-1E illustrate a droplet microfluidic device (designated 100) according to the present disclosure for effecting electrowetting based manipulations on a droplet D.

In this embodiment, as shown in FIG. 1A, droplet D is sandwiched between a lower plate, designated 100L, and an upper plate, designated 100U. The terms “upper” and “lower” are used in the present context only to distinguish these two planes 100L and 100U, and not as a limitation on the orientation of the planes 100L and 100U with respect to horizontal. Conventionally, the upper plate (100U) is also called the cover plate, the lower plate (100L) is also called the control plate. The droplet control electrodes, designated 104, are disposed on the lower plate 100L.

In some embodiments, the material for making the lower plate or the upper plate may not be important as long as the surface where the electrodes are disposed is (or is made) electrically non-conductive. The material may, in some embodiments, also be rigid enough so that the lower plate and/or the upper plate can substantially keep their original shape and gap size once made. The lower plate and/or the upper plate can be made of (not limited to) glass, ceramic, quartz, silicon, or polymers such as polycarbonate (PC), polyethylene terephthalate (PET), or cyclic olefin copolymer (COC), etc.

In some embodiments, the number of droplet control electrodes 104 can range from 2 to 1,000,000, from 2 to 100,000, or from 2 to 10,000. In some embodiments, the width of each electrode is between approximately 0.001 mm to approximately 100 mm, from 0.01 mm to 10 mm, or from 0.05 mm to 5 mm. In some embodiments, the spacing between adjacent the droplet control electrodes is between approximately 0.0001 mm to approximately 20 mm, from 0.001 mm to 10 mm, or from 0.01 mm to 5 mm. In some embodiments, the distance between the lower plate and the upper plate, the gap size, is between approximately 0.001 mm to approximately 5 mm, from 0.01 mm to 1 mm, or from 0.1 mm to 0.5 mm. The thickness of the electrodes can be from 1 nm (nano-meter) to 100 um (micrometer), from 5 nm to 10 um, or from 10 nm to 1 um.

Layers 105, 106, and 107 are thin films of dielectric materials, which can be, but not limited to, Teflon, Cytop, SUB, Parylene C, silicon dioxide, and the like. In some embodiments, the thickness of the dielectric materials is 1 nm (nano-meter) to 100 μm (micrometer), from 5 nm to 10 μm, or from 10 nm to 1 μm.

Layer 115 is a layer of conductive material, which can be, but not limited to, ITO, aluminum, copper, etc. In some embodiments, layer 115 is electrically grounded.

In some embodiments, the spaces between adjacent electrodes can be filled with dielectric material(s) when the covering dielectric layer is disposed. These spaces can also be left empty or filled with gas such as air or nitrogen.

FIG. 1B shows the layer of the conducting lines 102 for providing control voltages to the corresponding droplet control electrodes in another conductive layer. FIG. 10 show the dielectric layer 105 where VIAs 103 provide electrical pathways for the control voltages to go through. FIG. 1D shows the layer with droplet control electrodes. FIG. 1E is the combined view of the droplet control electrodes, the VIAs within the dielectric layer 105, and the connection lines.

As a small opening, a VIA can be round, square, rectangular, or an irregular shape. The size of a VIA can be less than 500 μm (micrometer), less than 200 μm, or less than 100 μm.

In some embodiments, the droplet control voltage can be less than 250 volts in amplitude and less than 100 MHz in frequency, less than 100 volts in amplitude and less than 10 MHz in frequency, or less than 50 volts in amplitude and less than 1 MHz in frequency.

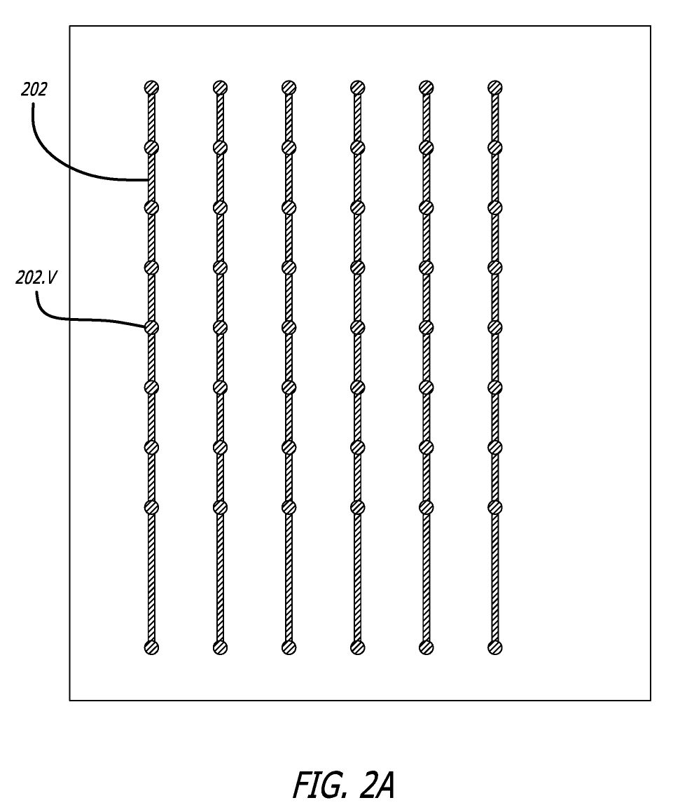

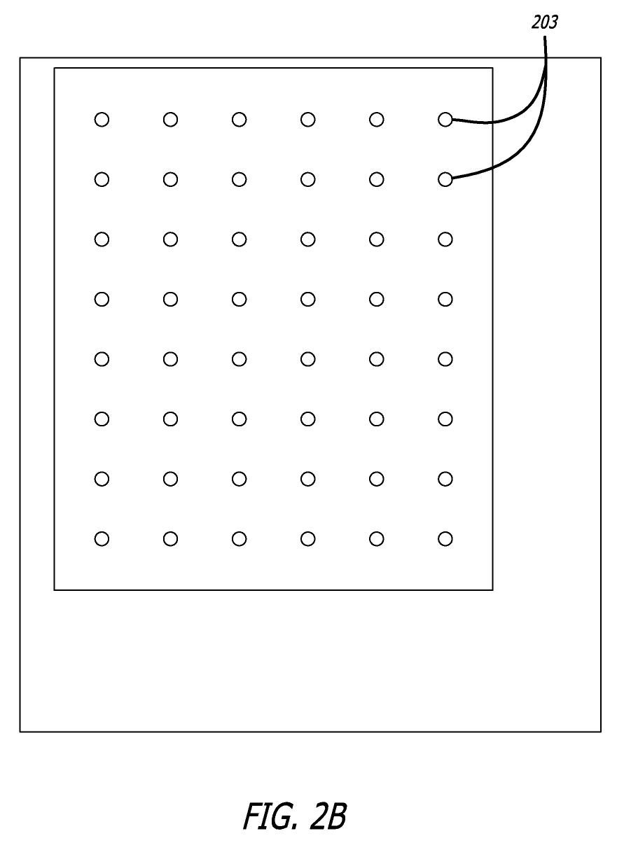

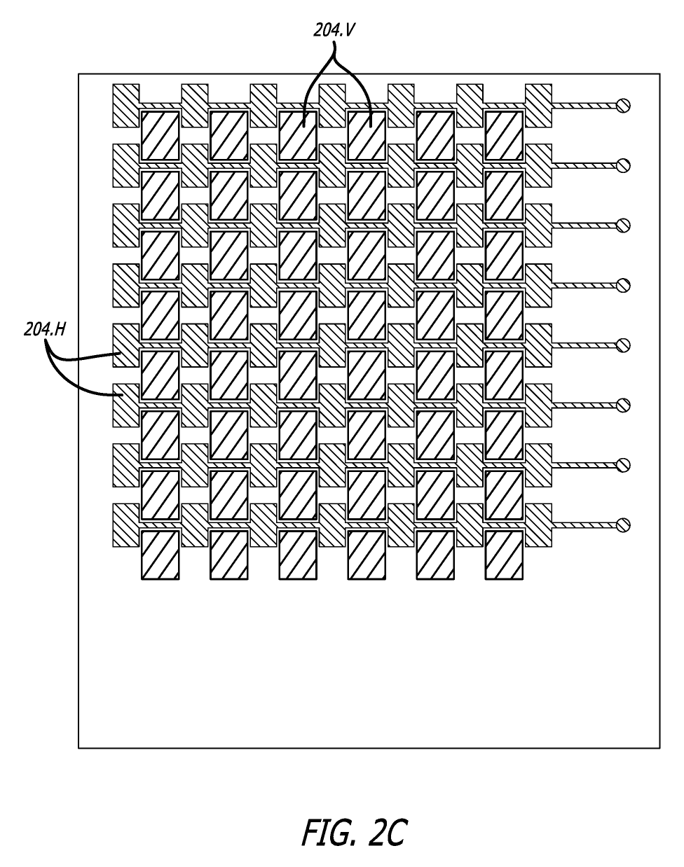

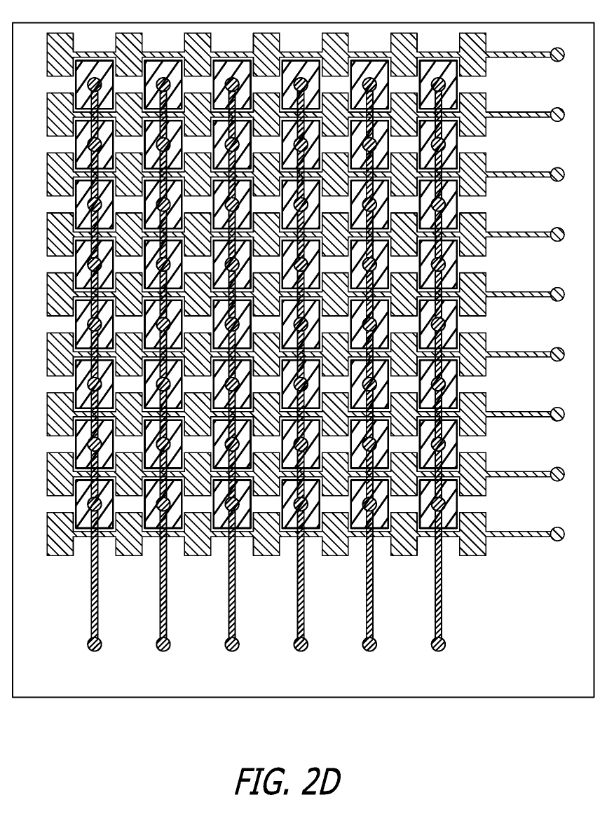

FIGS. 2A-2D illustrate the design of another embodiment of a droplet microfluidic device according to the present disclosure with droplet control electrodes and signal routing signals in different conductive layers. VIAs are made in the dielectric layer to provide conduits for the control voltage signals to be connected to the corresponding droplet control electrodes. FIG. 2A shows the design of the conducting lines 202 for providing control voltages to the corresponding droplet control electrodes. Point 202.V shows the positions on the conducting lines which are aligned with the VIAs 203 in the dielectric layer shown in FIG. 2B. FIG. 2C shows the droplet control electrodes layer with droplet control electrodes 204.H and 204.V. Connection lines are also made in this layer to provide control voltages to electrodes 204.H. FIG. 2D is the combined view of the droplet control electrodes, the VIAs, and the conducting lines.

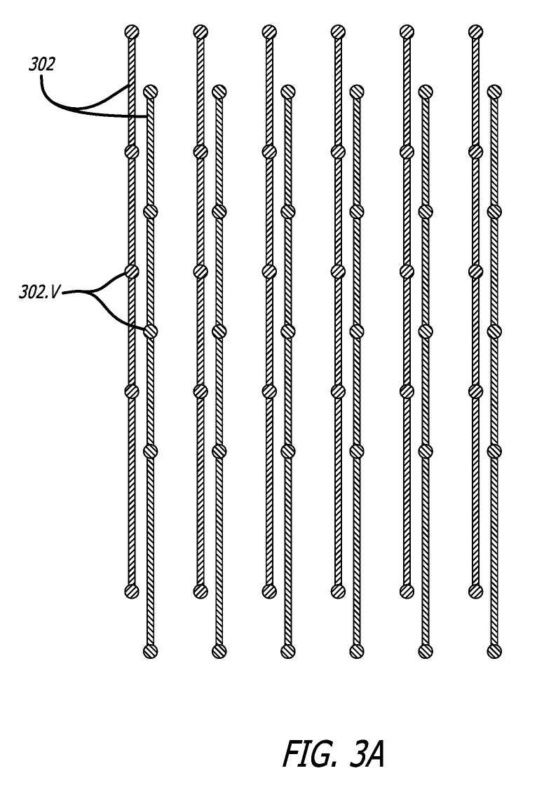

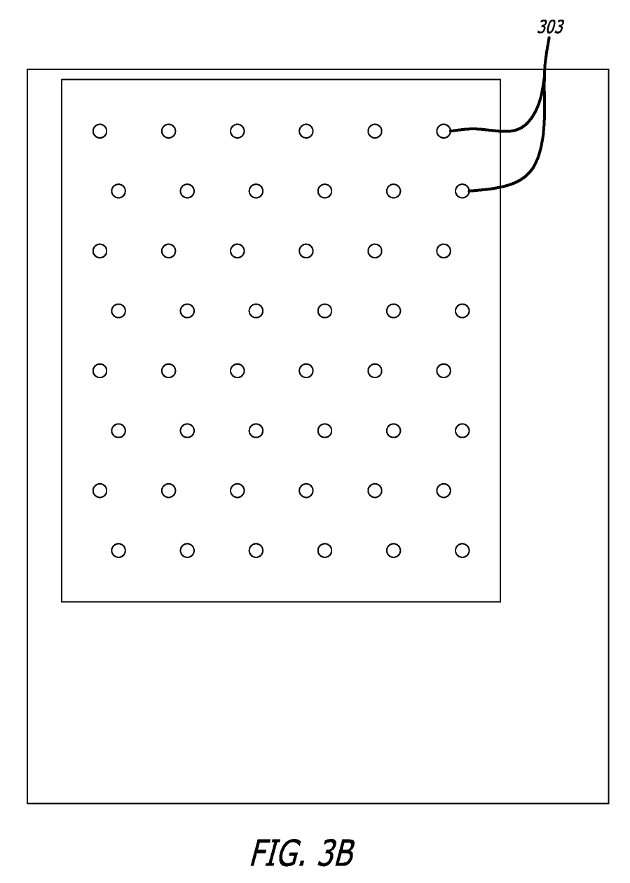

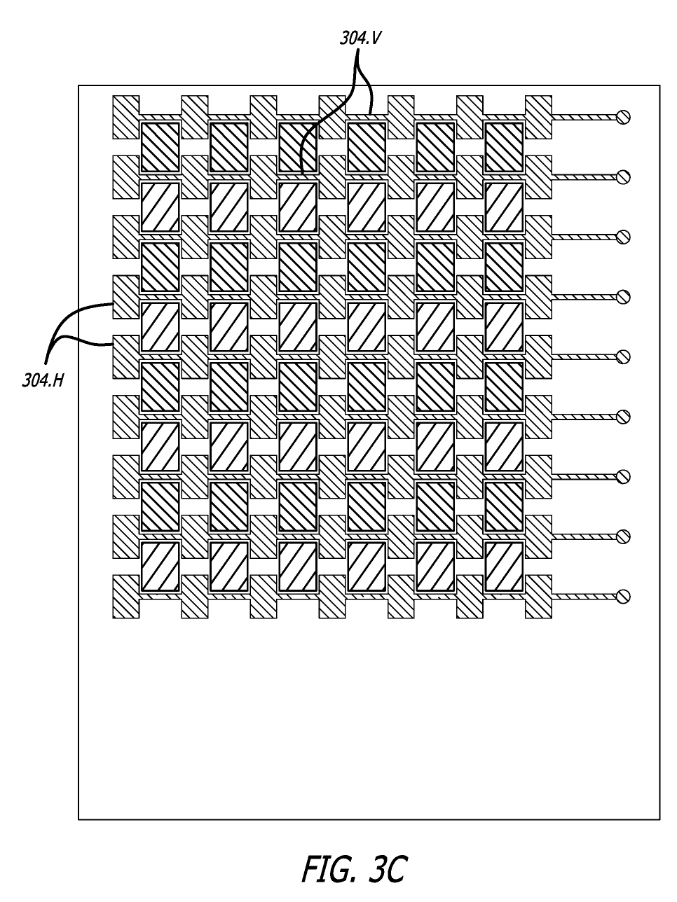

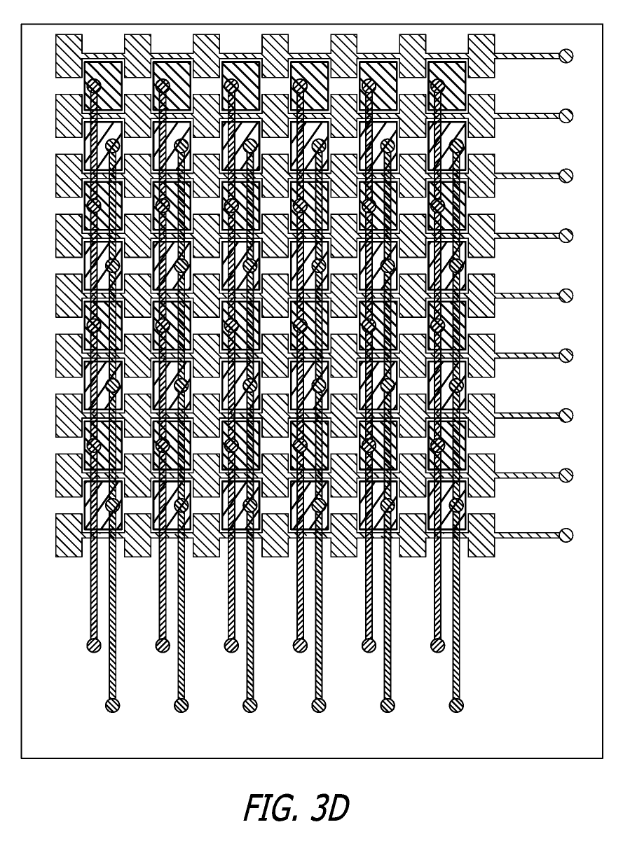

FIGS. 3A-3D illustrate the design of yet another embodiment of a droplet microfluidic device according to the present disclosure with droplet control electrodes and signal routing signals in different conductive layers. VIAs are made in the dielectric layer to provide conduits for the signals to be connected to the corresponding droplet control electrodes. FIG. 3A shows the design of the conducting lines 302 for providing control voltages to the corresponding electrodes. Points 302.V show the positions on the conducting lines which are aligned with the VIAs 303 in the dielectric layer shown in FIG. 3B. FIG. 3C shows the conductive layer with droplet control electrodes 304.H and 304.V. Connection lines are also made in this layer to provide control voltages to electrodes 304.H. FIG. 3D is the combined view of the droplet control electrodes, the VIAs, and the conducting lines.

In some embodiments, the upper plates, although not explicitly described, for the DMF device designs in FIGS. 2A-2D and FIGS. 3A-3D can be essentially the same as the upper plate 100U in FIG. 1A.

In some embodiments, none of the devices presented have active components, such as thin film transistors (TFTs), for the control of droplets. One potential advantage of the described devices is that manufacturing cost are kept low while maintaining desirable reliability.

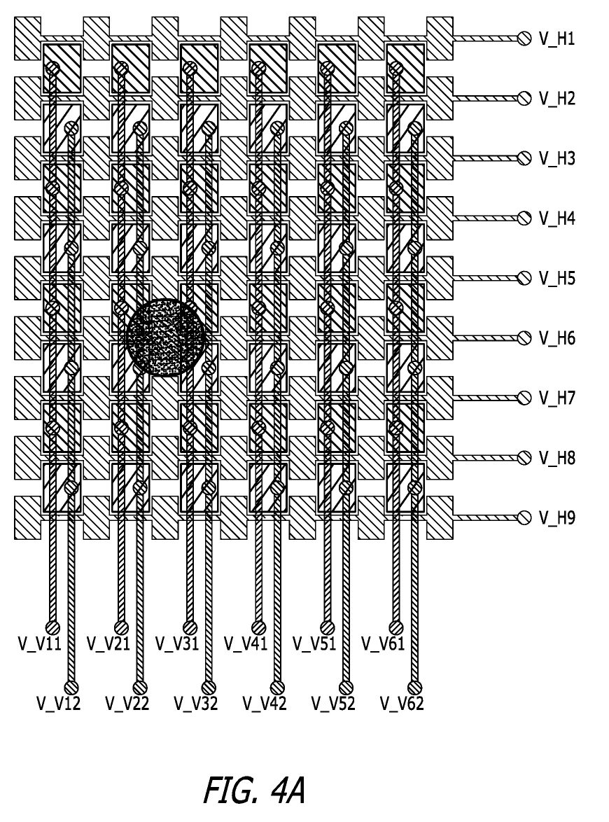

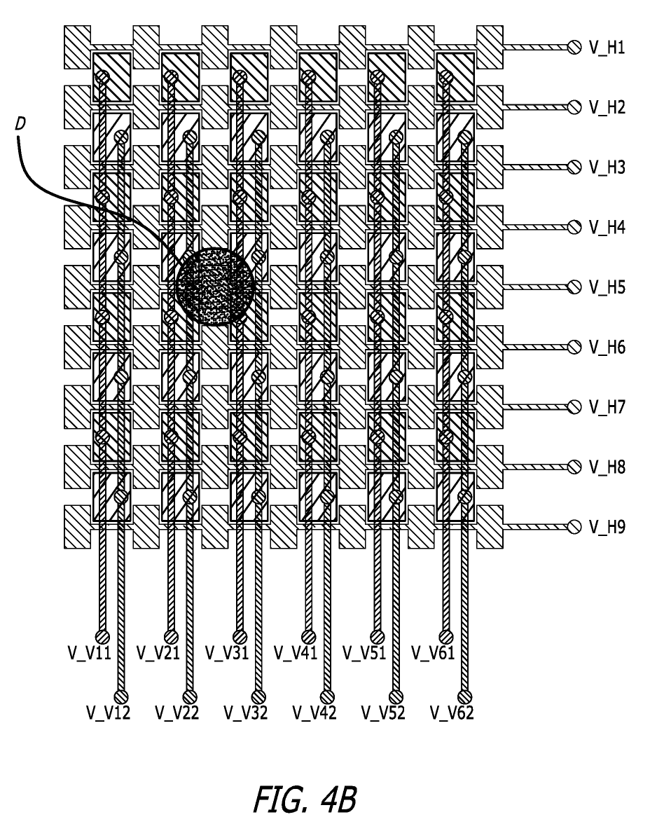

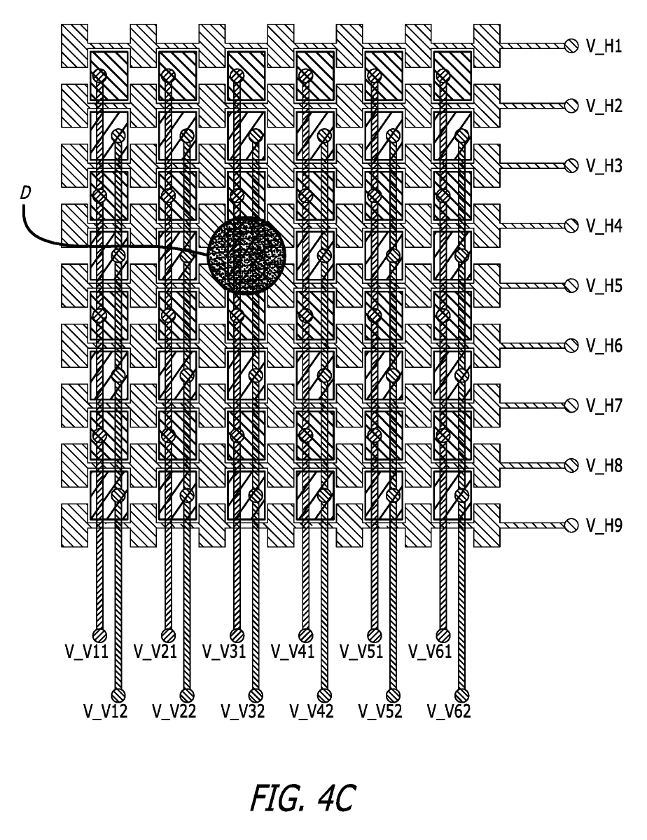

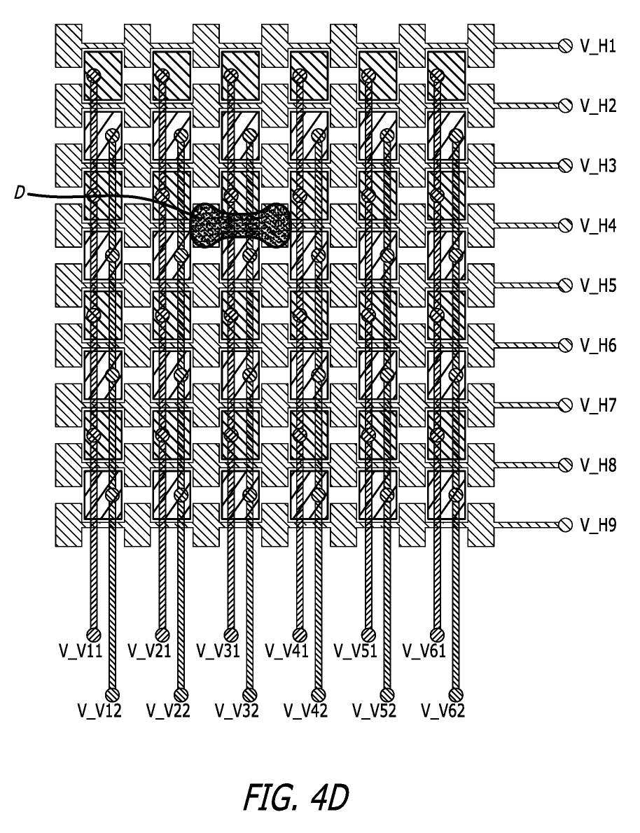

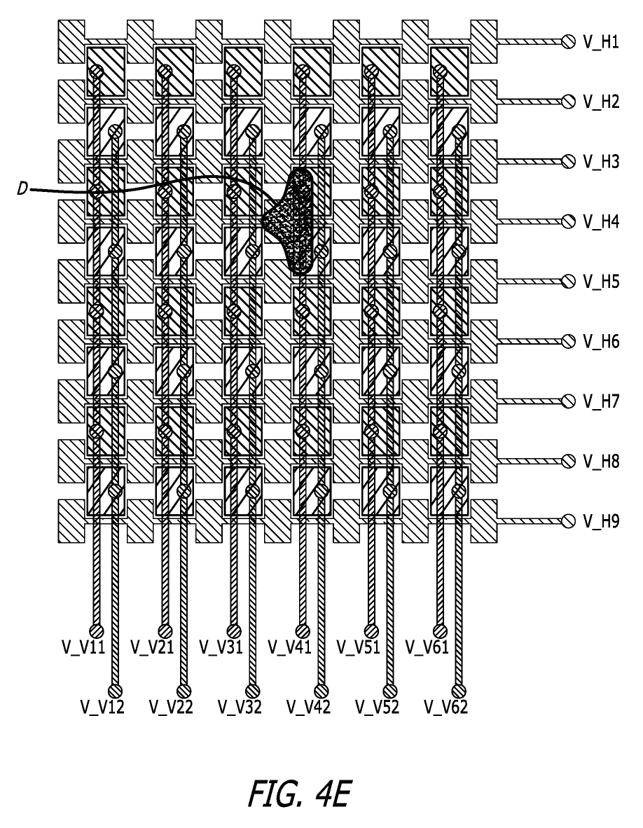

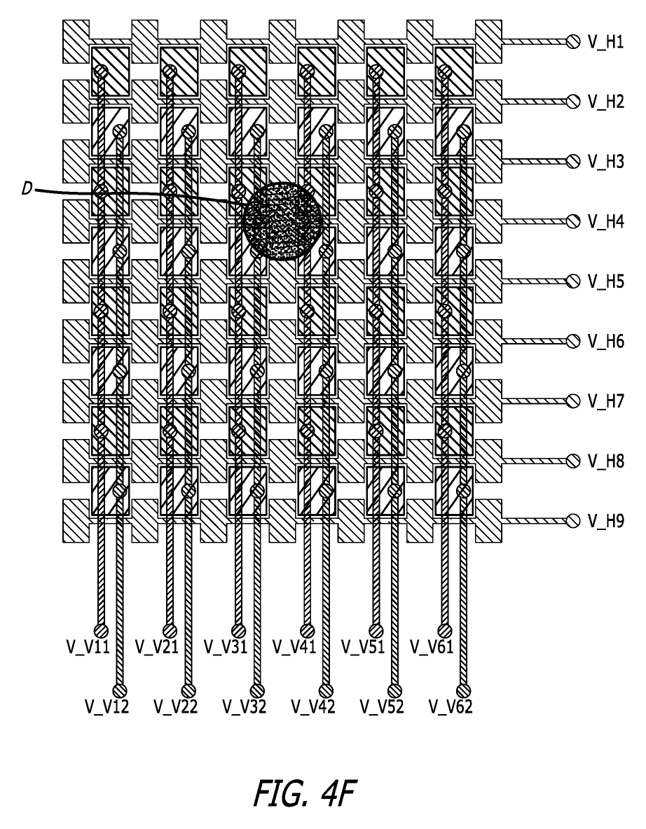

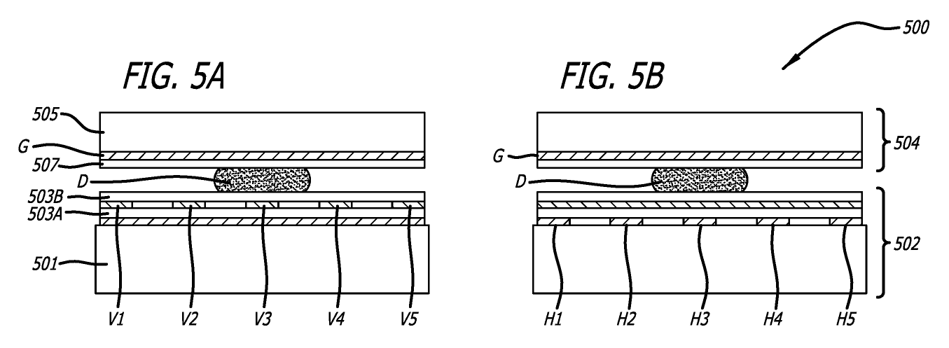

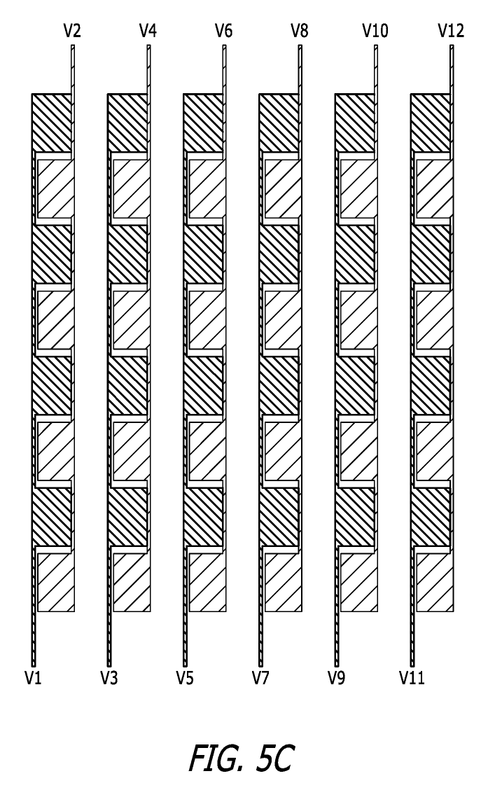

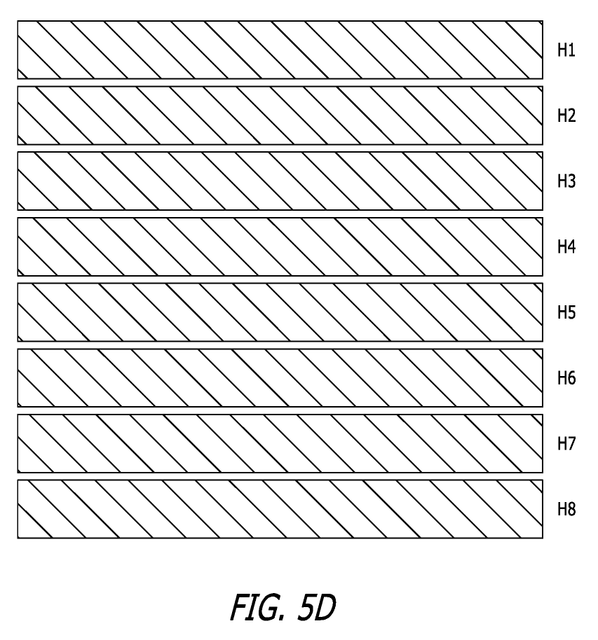

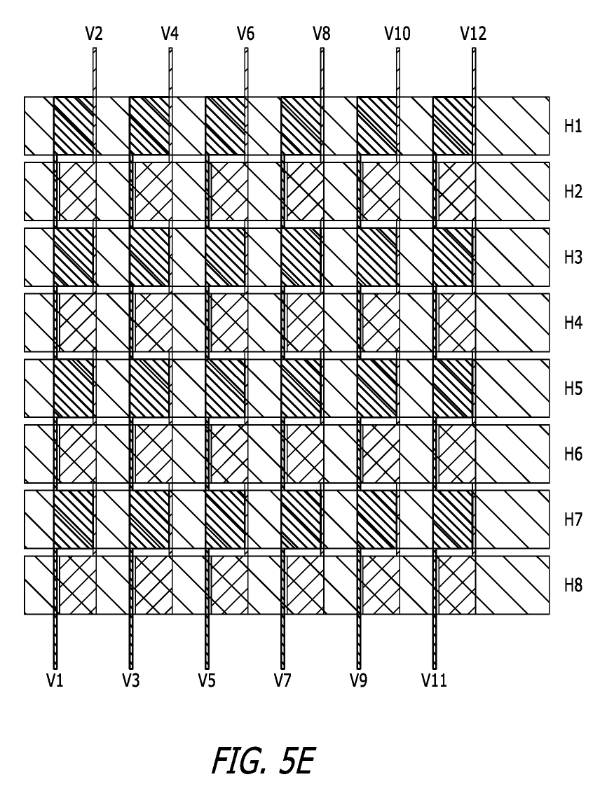

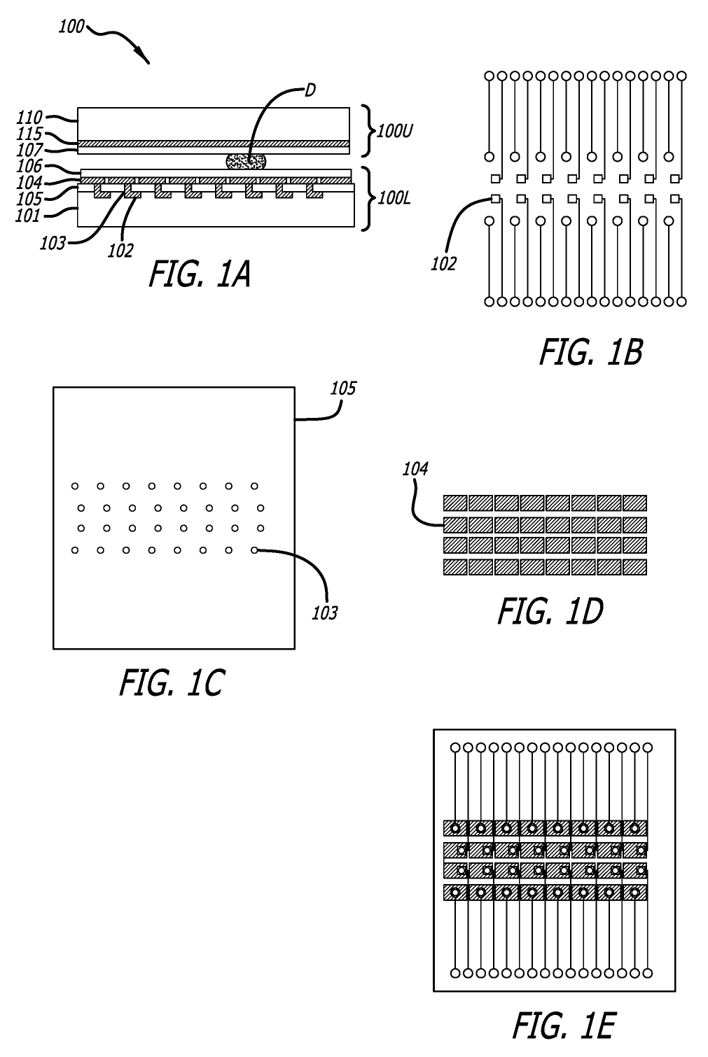

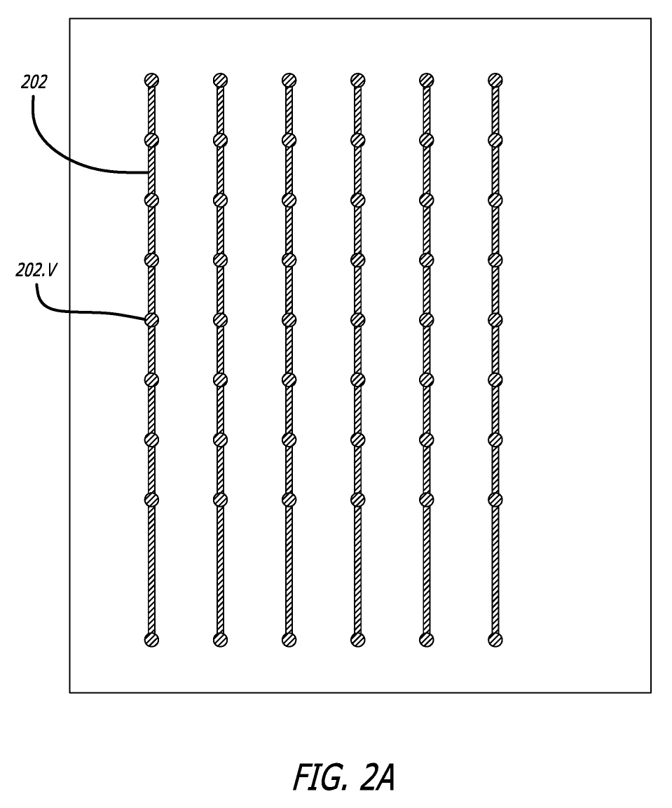

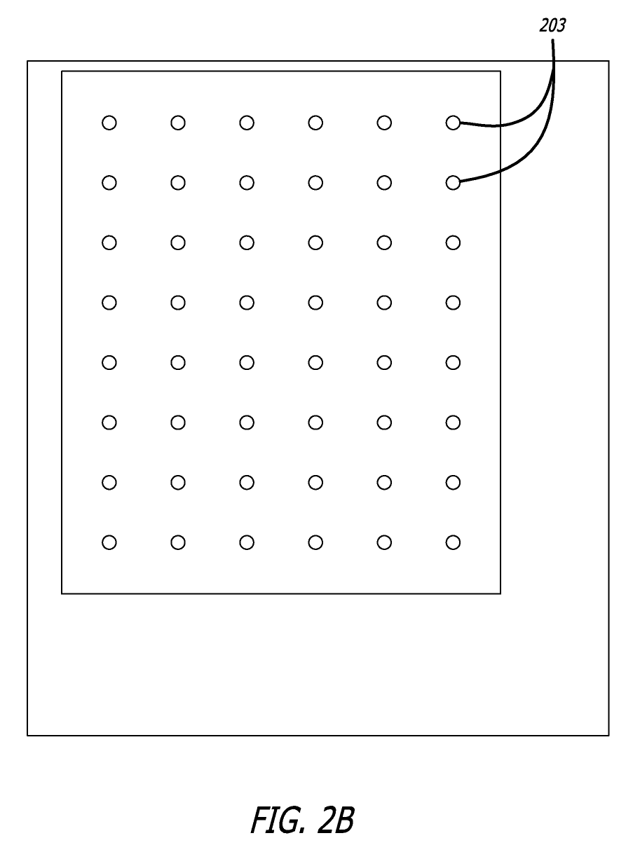

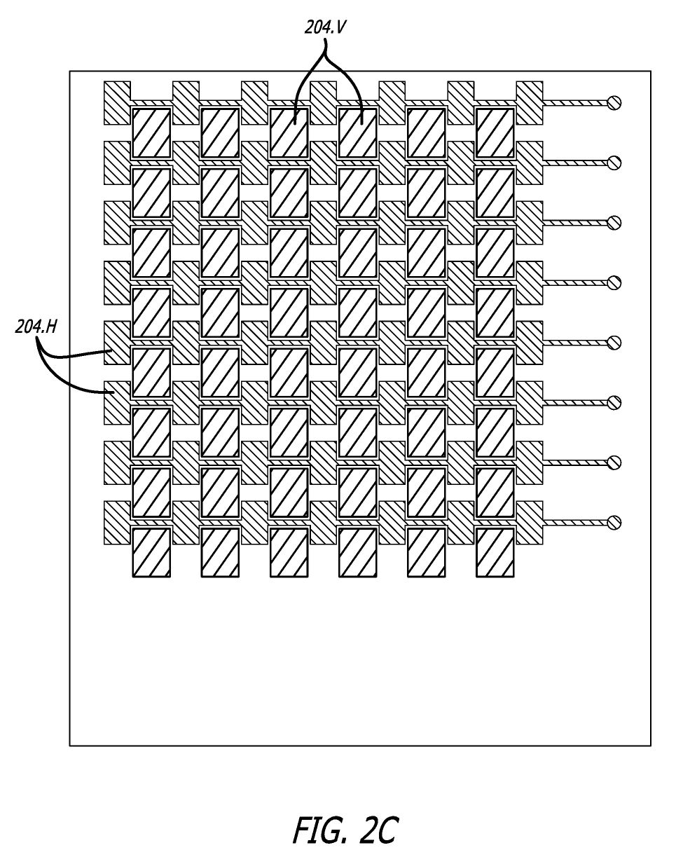

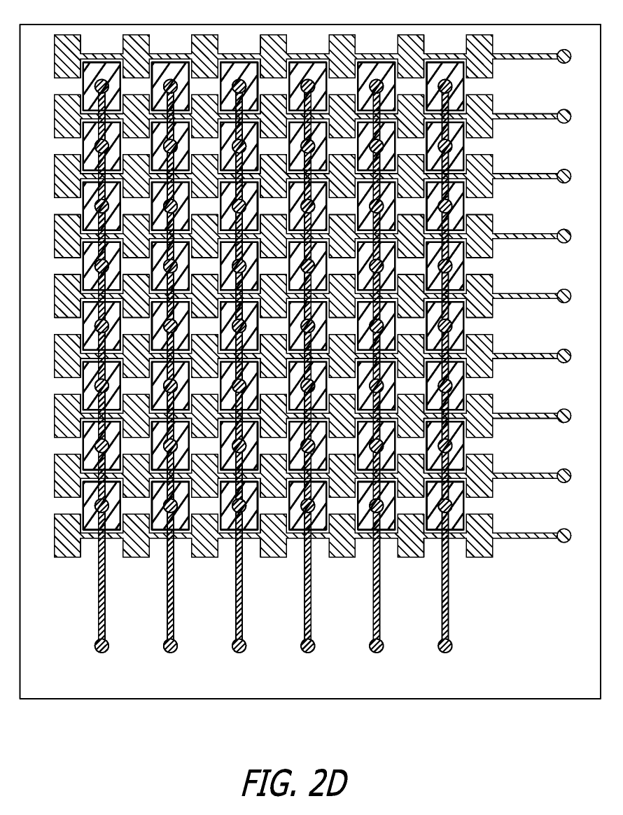

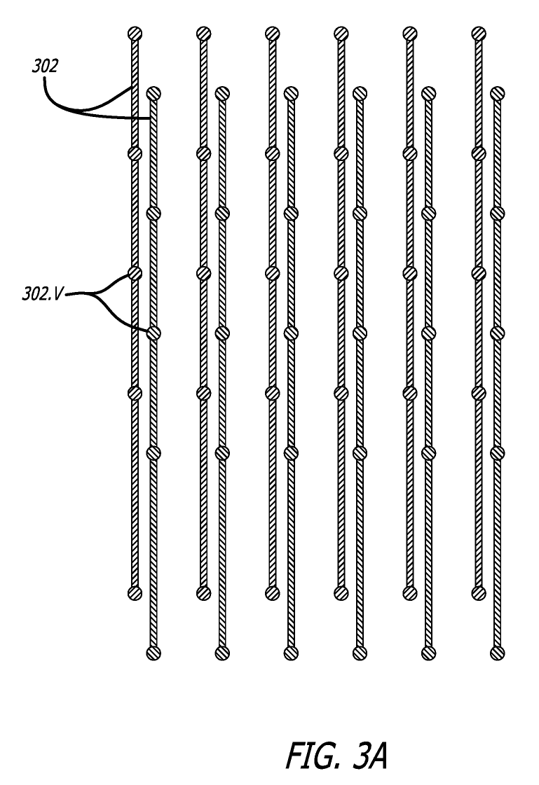

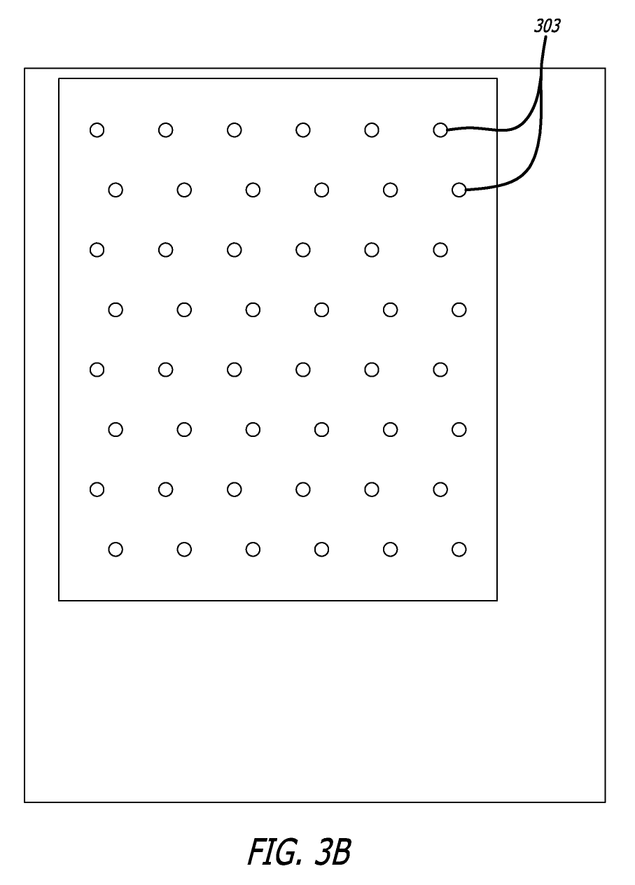

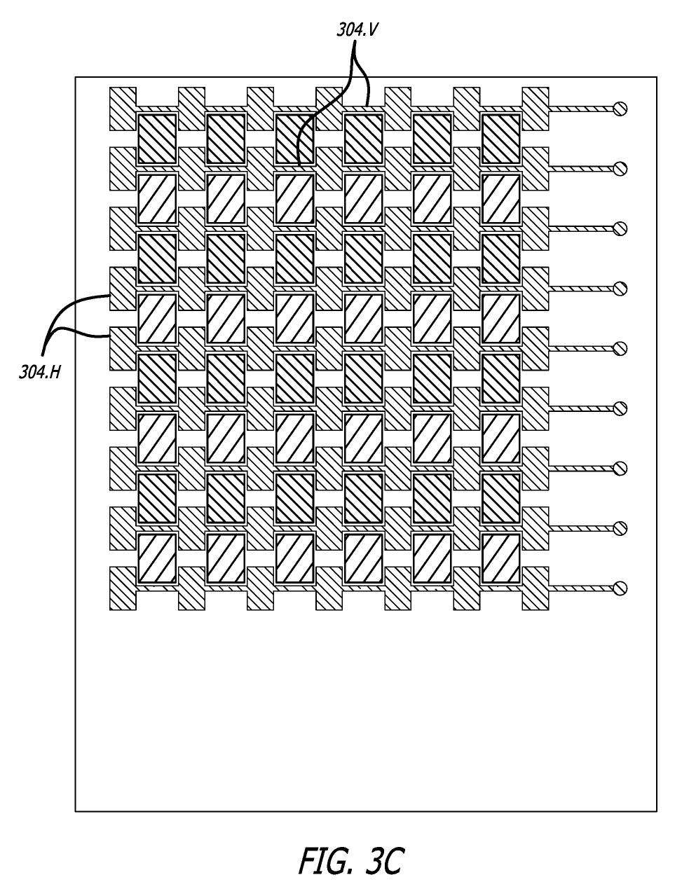

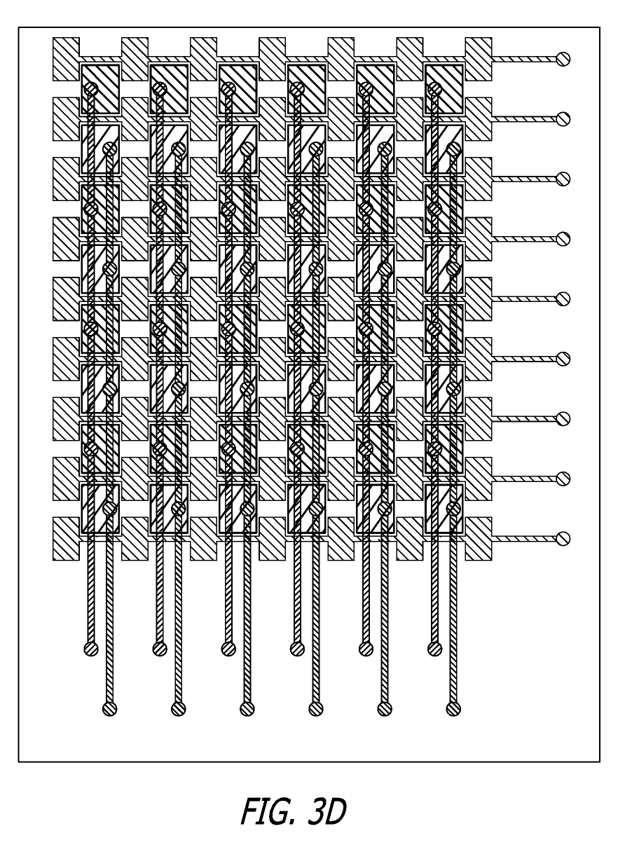

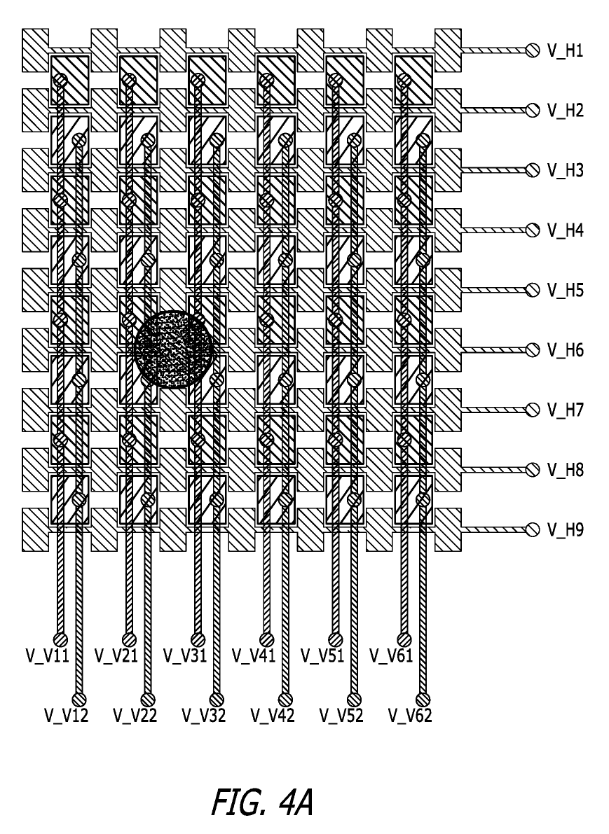

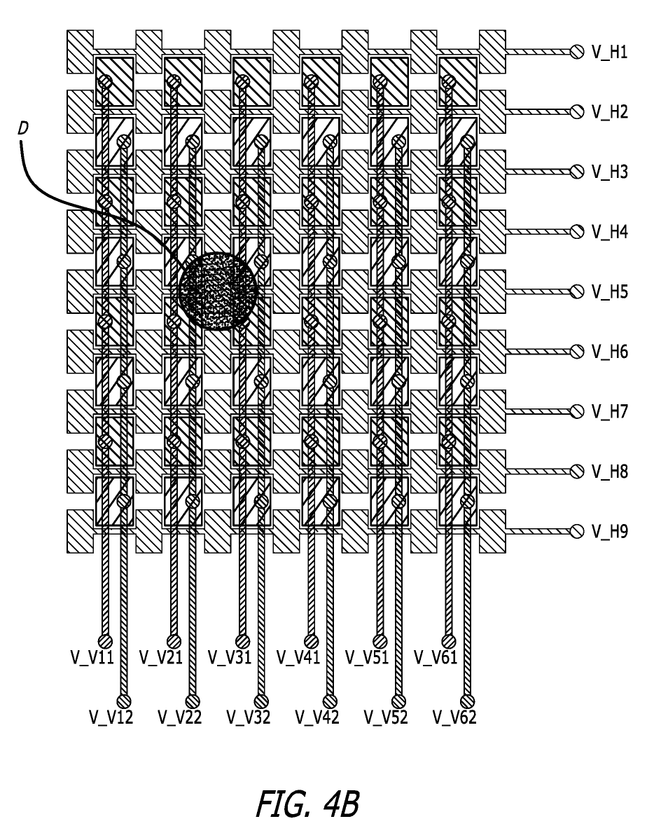

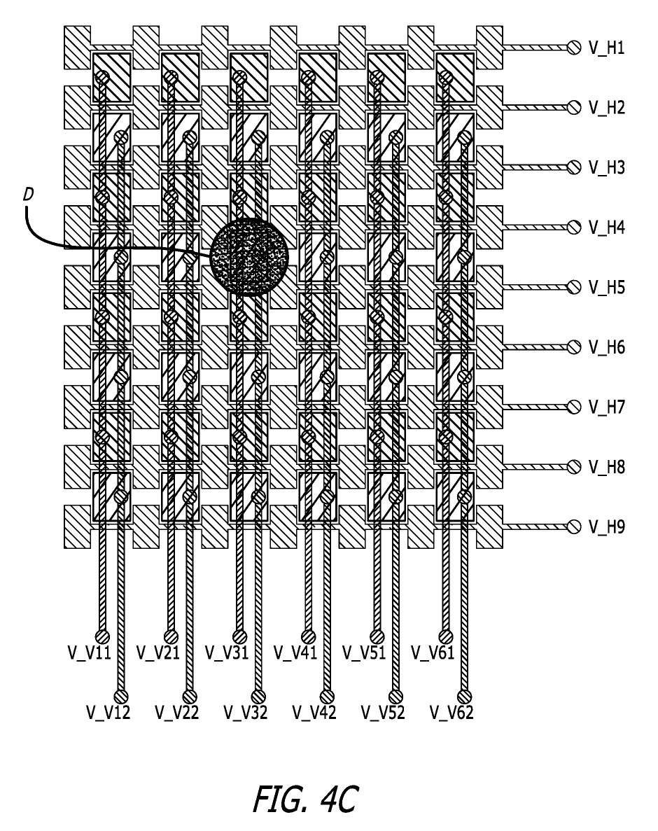

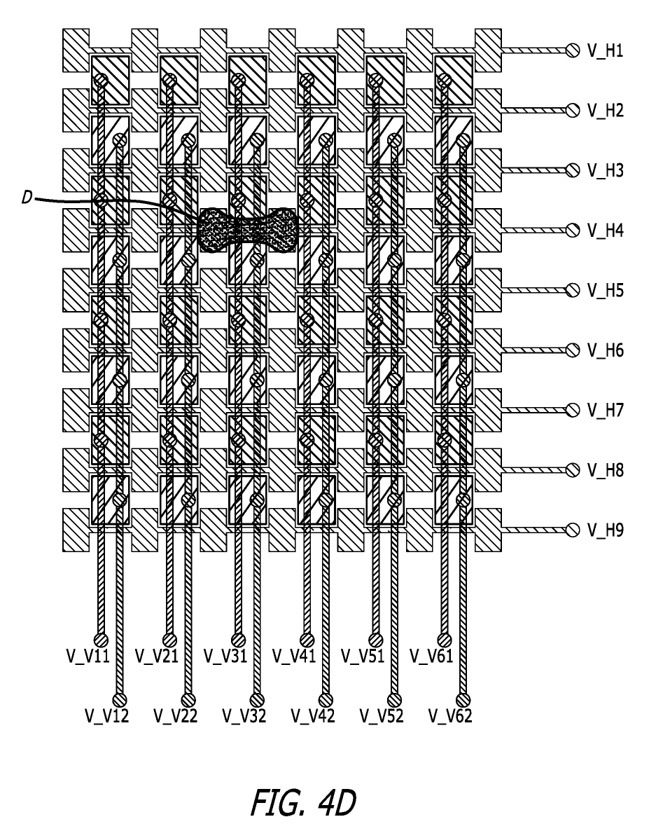

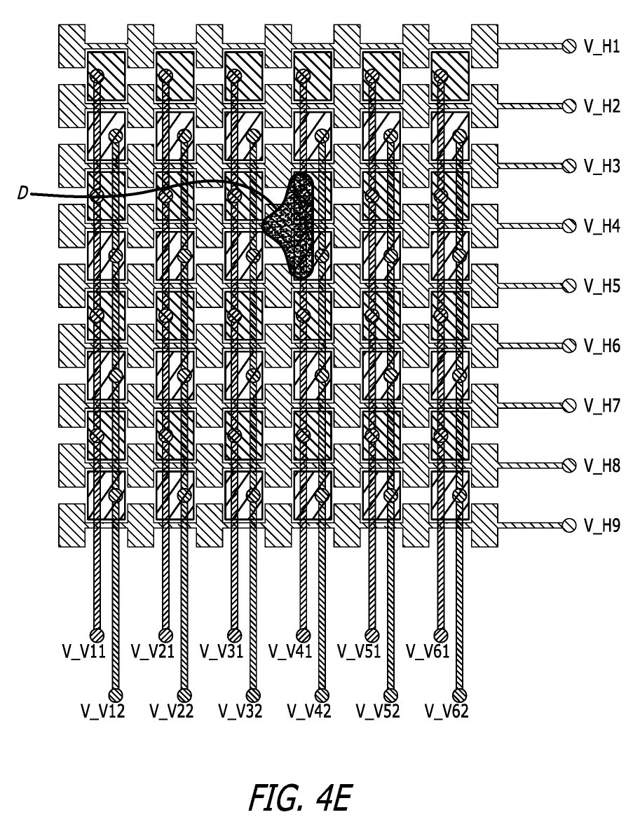

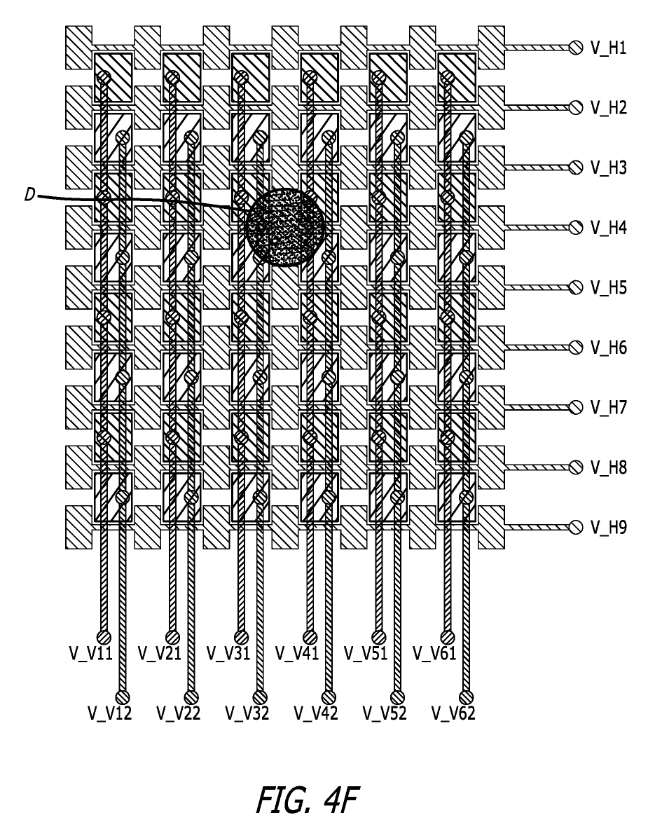

FIGS. 4A-4F show a droplet transport operation using the device design presented in FIGS. 3A-3D. Initially, a droplet D is located at the cross section of horizontal electrode V_H6 and vertical electrodes V_V22/V_V31, as shown in FIG. 4A. By applying voltage to V_H5, the droplet is moved up to the cross section of horizontal electrode V_H5 and vertical electrodes V_V22/V_V31, as shown in FIG. 4B. The applied voltage is then removed after the droplet move. By applying voltage to V_V32, the droplet is moved upper-right up to the cross section of vertical electrode V_V32 and between horizontal electrodes V_H5 and V_H4, as shown in FIG. 4C. Again, the applied voltage is removed after the droplet move.

Now, when a control voltage is applied to the horizontal electrode V_H4, the droplet can first move up and then change to a dump-bell shape due to the electrowetting effect from electrode V_H4, shown as in FIG. 4D. By applying voltage to vertical electrodes V_V41 and V_V42, and then releasing the voltage applied to V_H4 for a short period of time, the droplet can move and change its shape accordingly, as shown in FIG. 4E. By applying voltage to V_H4 again and in the mean time releasing the voltages to V_V41 and V_V42, the droplet can then move left, as shown in FIG. 4F.

Other droplet operations such as droplet splitting, merging, mixing, and incubating, etc., can also be implemented using this device design.

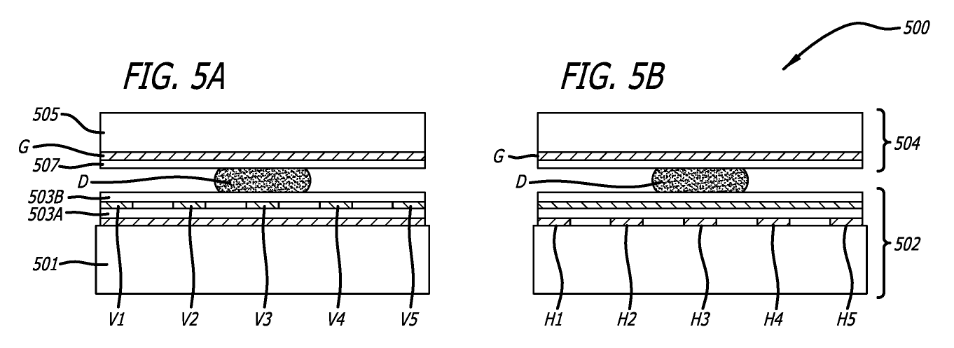

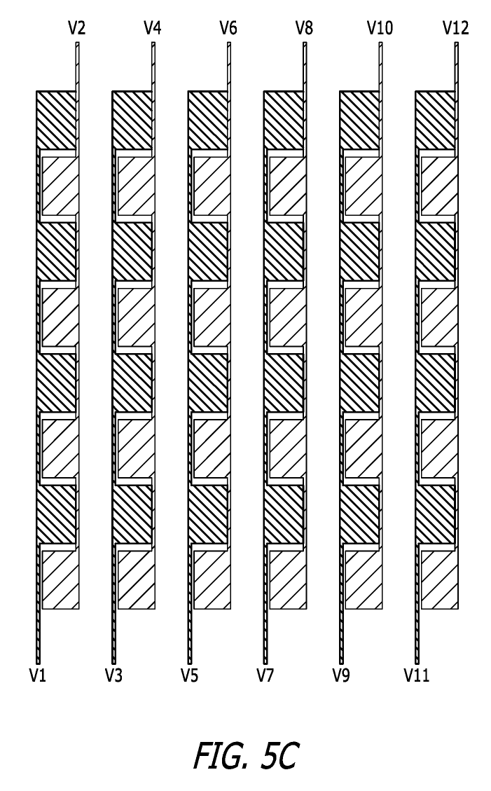

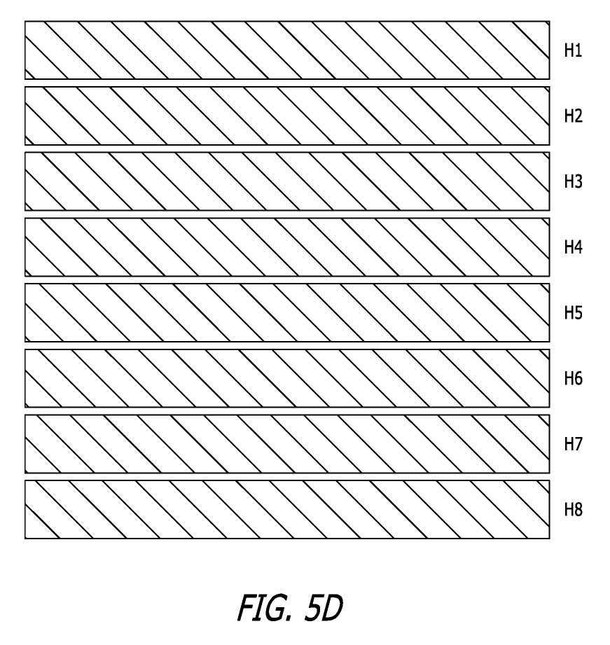

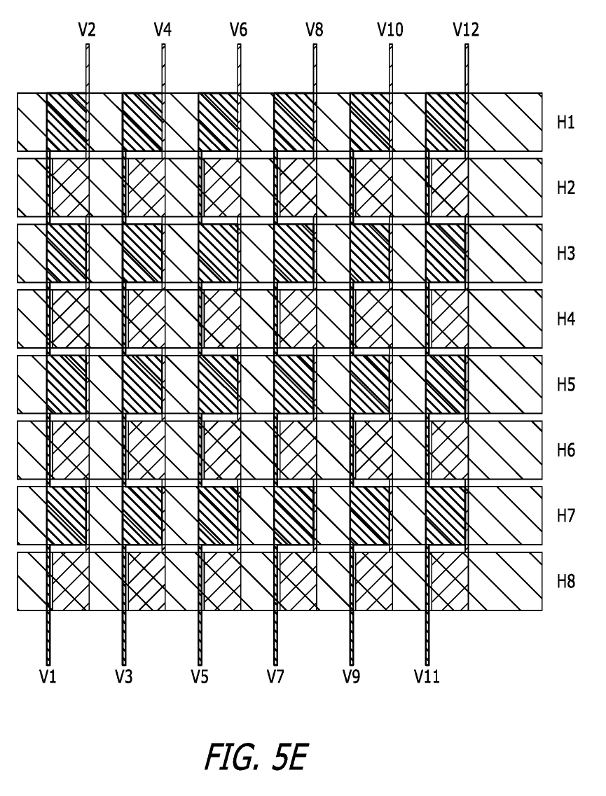

FIGS. 5A-5E depict a digital microfluidic device (designated 500) for effecting electrowetting based manipulations on a droplet D. Here, the droplet control electrodes are distributed in two isolated layers. Droplet manipulation between the device illustrated in FIGS. 5A-5E and the device described in FIGS. 3A-3D can be substantially similar.

As shown in FIGS. 5A and 5B, droplet D is sandwiched between a lower plate, designated 502, and an upper plate, designated 504. Some droplet control electrodes (H1, H2, H3, H4, and H5, etc.) are disposed in one (bottom) layer, and some droplet control electrodes (V1, V2, V3, V4, and V5, etc.) are disposed in another (top) layer. All these control electrodes are embedded in or formed on a suitable substrate 501. A thin lower layer 503A of dielectric material is applied to lower plate 501 to electrically isolate the droplet control electrodes in the two different layers. Another thin lower layer 503B of hydrophobic insulation is applied to lower plate 501 to cover droplet control electrodes V1, V2, V3, V4, and V5, etc. Upper plate 504 comprises a single continuous ground electrode embedded in or formed on a suitable upper substrate 505. Preferably, a thin upper layer 507 of hydrophobic insulation is also applied to upper substrate 505 to isolate ground electrode G.

FIG. 5C shows the design of the electrodes in the top layer. FIG. 5D shows the design of the electrodes in the bottom layer. FIG. 5E is the combined view of all the droplet control electrodes.

The device design, such as the design of the droplet control electrodes, in FIGS. 3A to 3D, offers more simplified droplet control and better device reliability than previous designs. The voltage difference between two droplet control electrodes in different layers in FIG. 5A, 5B, or 5D, can cause breakdown of the dielectric material between the two electrode layers. In the device design in FIGS. 3A to 3D, there is no vertical overlap between any two droplet control electrodes, which reduces the chance of dielectric breakdown. Also, since all the droplet control electrodes are at the same level (or the same vertical distance from the droplet), the amplitude of droplet control voltage can essentially be the same for all the electrodes, hence simplifying the droplet control.

It should be mentioned that the above described examples and the above-mentioned advantages are by no means exhaustive.

While the preferred embodiments of the invention have been illustrated and described, it will be appreciated that various changes can be made therein without departing from the spirit and scope of the invention.

The above described embodiments are only used to illustrate the principles and their effects of this invention, and are not used to limit the scope of the invention. For people who are familiar with this technical field, various modifications and changes can be made without violating the spirit and scope of the invention. So, all modifications and changes without departing from the spirit and technical guidelines by anyone with common knowledge in this technical field are still covered by the current invention.

1. An apparatus for droplet manipulations, comprising
a) a first substrate comprising a first substrate surface;
b) an array of electrically conducting lines disposed on the first substrate surface;
c) a first dielectric layer disposed on the first substrate surface to cover at least some of the conducting lines;
d) an array of electrically isolated droplet control electrodes disposed on the first substrate surface, wherein at least some of said electrodes are connected to the conducting lines through the VIAs patterned in the first dielectric layer;
e) a second dielectric layer disposed on the first substrate surface to cover at least some of the droplet control electrodes.

2. The apparatus according to claim 1, wherein the first substrate is optically transparent.

3. The apparatus according to claim 1, wherein at least a portion of the second dielectric layer is hydrophobic.

4. The apparatus according to claim 1, wherein the droplet control electrodes are in two layers separated by a layer of dielectric material.

5. The apparatus according to claim 1, comprising an electrode selector for sequentially activating and de-activating one or more selected droplet control electrodes to sequentially bias the selected droplet control electrodes actuation voltages, whereby a droplet disposed on the substrate surface moves along a desired path defined by the selected droplet control electrodes.

6. The apparatus according to claim 5, wherein the electrode selector comprises an electronic processor.

7. The apparatus according to claim 1, wherein the droplet is an electrolyte.

8. The apparatus according to claim 1, comprising a droplet inlet communicating with the surface.

9. The apparatus according to claim 1, comprising a droplet outlet communicating with the surface.

10. The apparatus according to claim 1, comprising a second substrate surface facing the first substrate surface, spaced from the first substrate surface by a distance to define a space between the first and the second substrates, wherein the distance is sufficient to contain a droplet disposed in the space.

11. The apparatus according to claim 10, wherein an electrode is disposed on said second substrate surface.

12. The apparatus according to claim 10, wherein a third dielectric layer is disposed on said second substrate surface to cover at least a portion of the electrode.

13. The apparatus according to claim 12, wherein at least a portion of the third dielectric layer is hydrophobic.
